(19) United States
(12) Patent Application Publication
(10) Pub. No.: US 2026/0032626 A1
(43) Pub. Date: Jan. 29, 2026

(54) METHOD AND DEVICE FOR TRANSMITTING AND RECEIVING WIRELESS POSITIONING INFORMATION

(71) Applicant: FUJITSU LIMITED, Kawasaki-shi (JP)

(72) Inventors: Yujia SHAN, Beijing (CN); Xin WANG, Beijing (CN)

(73) Assignee: FUJITSU LIMITED, Kawasaki-shi (JP)

(21) Appl. No.: 19/346,650

(22) Filed: Oct. 1, 2025

Related U.S. Application Data
(63) Continuation of application No. PCT/CN2023/086737, filed on Apr. 6, 2023.

(51) Int. Cl. H04W 64/00

(52) U.S. Cl. CPC H04W 64/00

(57) ABSTRACT

A device for transmitting wireless positioning information configured in a terminal equipment, includes: acquiring processor circuitry configured to acquire label data for wireless positioning and quality related information corresponding to the label data; and a transmitter configured to transmit the label data and/or the quality related information corresponding to the label data to a network device.

### CROSS-REFERENCE TO RELATED APPLICATION

This application is a continuation application under 35 U.S.C. 111 (a) of International Patent Application PCT/CN2023/086737 filed on Apr. 6, 2023, and designated the U.S., the entire contents of which are incorporated herein by reference.

### TECHNICAL FIELD

This disclosure relates to the field of communication technologies.

### BACKGROUND

With the commercialization of the fifth generation (5G) communications, especially the large-scale development of the industrial Internet industry, demands for wireless positioning of a terminal equipment in wireless communications have increased dramatically. Traditional wireless positioning is based on a plurality of technologies, such as TDOA (Time Difference of Arrival), E-CID (Enhanced Cell ID) and Multi-RTT (Multi-Round-Trip Time). These traditional positioning methods have multiple inherent defects, which leads to poor positioning accuracy of the terminal equipment in different wireless environments or scenarios, especially in wireless environments with severe non-line of sight (NLOS), such as indoor factory (InF), or the like. The error values of traditional positioning methods are very large and usually difficult to accept. The fundamental reason is that it is difficult for the traditional positioning methods to accurately measure wireless environments with strong NLOS paths, and the obtained measured values themselves have significant deviations from ideal values, which leads to the generation of errors.

In recent years, artificial intelligence and machine learning (AI/ML) technologies, represented by deep learning, have developed rapidly and have been applied to a plurality of research and commercial fields due to their powerful nonlinear fitting capabilities. Similarly, the evaluation performance of artificial intelligence applications in wireless positioning has been significantly improved over traditional methods.

For example, a widely studied “direct” artificial intelligence positioning model uses watermarking technologies to attempt to fit a nonlinear relationship between a channel impulse response (CIR) between a plurality of network devices (such as base stations) and target devices (UE) and coordinate positions of the target devices, and has been proven in a plurality of different experiments to achieve positioning accuracy multiple times higher than the traditional positioning methods.

However, bottlenecks emerge in the application and deployment of AI/ML models in wireless positioning as the research progresses. One of the problems is that AI/ML models are data-driven learning algorithms. When the model trained based on specific input data is deployed in an unfamiliar environment, the AI/ML models often have poor inference performance due to the poor correlation between characteristics of the input data and the training data. This problem is particularly prominent for the “direct watermark-based” AI/ML wireless positioning technology, because the models usually need to infer the location of the terminal equipment based on channel characteristics between a plurality of network devices (such as base stations) and terminal equipment (such as UE). Once the channel between one of the network devices and the terminal equipment changes, such an input-output relationship learned during training is no longer applicable, and continued use of this incorrect correspondence inevitably results in poor model performance.

In response to the above problems, the industry is exploring a plurality of solutions. One of the methods is to collect channel measurement data of the current environment when the AI/ML models enter the unfamiliar environment to retrain or fine-tune the models in order to improve the generalization of the models, and/or to collect the channel measurement data of the current environment if the poor model performance is found, in order to supervise the performance of the current model.

It should be noted that the above introduction to the background is merely provided for clear and complete explanation of the technical solutions of this disclosure and for easy understanding by those skilled in the art. And it should not be understood that these technical solutions are known to those skilled in the art simply because they are described in the background of this disclosure.

### SUMMARY

However, the inventor finds that the training data and/or supervision data required for the AI/ML models included label (LABEL, also known as GROUND TRUTH) data. In wireless positioning applications, the label data corresponds to the precise geographic location (2D or 3D) of the terminal equipment in the current wireless environment, or the precise channel measurement result between the terminal equipment and the network device, such as TDOA, RSTD, ToA, AoA, channel LOS/NLOS indication information, etc. However, when the channel environment is harsh (for example, there exists a strong NLOS path) or when the terminal equipment or the network device itself has a large measurement error, these label data are often not available to the device deploying the AI/ML models.

To address at least one of the above problems, embodiments of this disclosure provide a method and device for transmitting and receiving wireless positioning information. By transmitting the label data for wireless positioning and the corresponding quality related information between the network device and the terminal equipment, the device deploying the AI/ML models can make decisions on optimization of the current model according to the quality related information of the label data even when entering an unfamiliar environment, thus the generalization of the models can be improved and the accuracy of wireless positioning of the AI/ML models can be improved.

According to an aspect of the embodiments of this disclosure, there is provided a method for transmitting wireless positioning information, including:
acquiring, by a terminal equipment, label data for wireless positioning and quality related information corresponding to the label data;
transmitting, by the terminal equipment, the label data and/or the quality related information corresponding to the label data to a network device.

According to another aspect of the embodiments of this disclosure, there is provided a device for transmitting wireless positioning information configured in a terminal equipment, including:
an acquiring unit configured to acquire label data for wireless positioning and quality related information corresponding to the label data; and
a transmitting unit configured to transmit the label data and/or the quality related information corresponding to the label data to a network device.

According to another aspect of the embodiments of this disclosure, there is provided a method for receiving wireless positioning information, including:
receiving, by a network device, label data for wireless positioning and quality related information corresponding to the label data from a terminal equipment.

According to another aspect of the embodiments of this disclosure, there is provided a device for receiving wireless positioning information configured in a network device, including:
a receiving unit configured to receive label data for wireless positioning and quality related information corresponding to the label data from a terminal equipment.

According to another aspect of the embodiments of this disclosure, there is provided a communication system, including:
a terminal equipment configured to acquire label data for wireless positioning and quality related information corresponding to the label data, and transmit the label data and/or the quality related information corresponding to the label data to a network device; and
the network device configured to receive the label data and the quality related information corresponding to the label data.

One of the advantageous effects of the embodiments of this disclosure is that by transmitting the label data for wireless positioning and the corresponding quality related information between the network device and the terminal equipment, the device deploying the AI/ML models can make decisions on optimization of the current model according to the quality related information of the label data even when entering the unfamiliar environment, thus the generalization of the models can be improved and the accuracy of wireless positioning of the AI/ML models can be improved.

With reference to the following description and drawings, the specific embodiments of this disclosure are disclosed in detail, and the manners in which the principle of this disclosure can be used are indicated. It should be understood that the scope of the embodiments of this disclosure is not limited thereto. The embodiments of this disclosure contain multiple alternations, modifications and equivalents within the spirit and scope of the terms of the appended claims.

Features that are described and/or illustrated with respect to one embodiment may be used in a same way or in a similar way in one or more other embodiments, and/or in combination with or instead of the features of the other embodiments.

It should be emphasized that the term “comprise/include” when used in this specification refers to the presence of features, integers, steps or components, but does not exclude the presence or addition of one or more other features, integers, steps or components.

### BRIEF DESCRIPTION OF THE DRAWINGS

Elements and features depicted in one drawing or embodiment of this disclosure may be combined with elements and features depicted in one or more other drawings or embodiments. Moreover, in the drawings, like reference numerals designate corresponding parts throughout the several views and may be used to designate like or similar parts in more than one embodiment.

The included drawings are used to provide a further understanding of the embodiments of this disclosure, which constitute a part of the specification, are used to illustrate the embodiments of this disclosure and explain the principles of this disclosure together with the text description. Obviously, the drawings described below are only some embodiments of this disclosure. For those skilled in the art, other drawings can be obtained based on these drawings without creative effort. In the drawings:

FIG. 1 is a schematic diagram illustrating an application scenario according to embodiments of this disclosure;

FIG. 2 is a schematic diagram illustrating a method for transmitting wireless positioning information according to embodiments of this disclosure;

FIG. 3 is another schematic diagram illustrating a method for transmitting wireless positioning information according to embodiments of this disclosure;

FIG. 4 is an example diagram illustrating transmission of label data and/or quality related information between a UE and a LMF according to embodiments of this disclosure;

FIG. 5 is another example diagram illustrating transmission of label data and/or quality related information between a UE and a LMF according to embodiments of this disclosure;

FIG. 6 is another schematic diagram illustrating a method for transmitting wireless positioning information according to embodiments of this disclosure;

FIG. 7 is another schematic diagram illustrating a method for transmitting wireless positioning information according to embodiments of this disclosure;

FIG. 8 is a schematic diagram illustrating a method for receiving information according to embodiments of this disclosure;

FIG. 9 is a schematic diagram illustrating a method for receiving information according to embodiments of this disclosure;

FIG. 10 is a schematic diagram illustrating an information transmitting device according to embodiments of this disclosure;

FIG. 11 is a schematic diagram illustrating an information receiving device according to embodiments of this disclosure; and

FIG. 12 is a schematic diagram illustrating an electronic device according to embodiments of this disclosure.

### DETAILED DESCRIPTION

These and other features of this disclosure will be apparent with reference to the following description and drawings. In the description and drawings, specific embodiments of this disclosure have been disclosed in detail as being indicative of some of the embodiments in which the principles of this disclosure may be employed, but it should be understood that this disclosure is not limited to the embodiments described herein. Rather, this disclosure includes all amendments, variations and equivalents falling within the scope of the appended claims.

In the embodiments of this disclosure, terms “first”, “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include”, “have” refer to existence of stated features, elements, components, or assemblies, but do not exclude existence or addition of one or more other features, elements, components, or assemblies.

In the embodiments of this disclosure, singular forms “a”, “the”, etc., include plural forms, and should be understood as “a kind of” or “a type of” in a broad sense, but should not be limited to a meaning of “one”; and the term “the” should be understood as including both a singular form and a plural form, except clearly specified otherwise. Furthermore, the term “according to” should be understood as “at least partially according to”, the term “based on” should be understood as “at least partially based on”, except clearly specified otherwise.

In the embodiments of this disclosure, the term “communication network” or “wireless communication network” may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

And communication between devices in a communication system may be performed according to communication protocols at any stage, which may, for example, include but not limited to the communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses terminal equipment to a communication network and provides services for the terminal equipment. The network device may include but not limited to devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), an IAB host, etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographic area. And a term “cell” may refer to a base station and/or its coverage area, depending on a context in which the term is used.

In the embodiments of this disclosure, the term “user equipment” (UE) refers to, for example, equipment accessing to a communication network and receiving network services via a network device, and may also be referred to as “terminal equipment” (TE). The terminal equipment may be fixed or mobile, and may also be referred to as a mobile station (MS), a terminal, a user, a subscriber station (SS), an access terminal (AT), a station, etc.

The terminal equipment may include but not limited to devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

A scenario of an embodiment of this disclosure shall be described below by way of examples. However, this disclosure is not limited thereto.

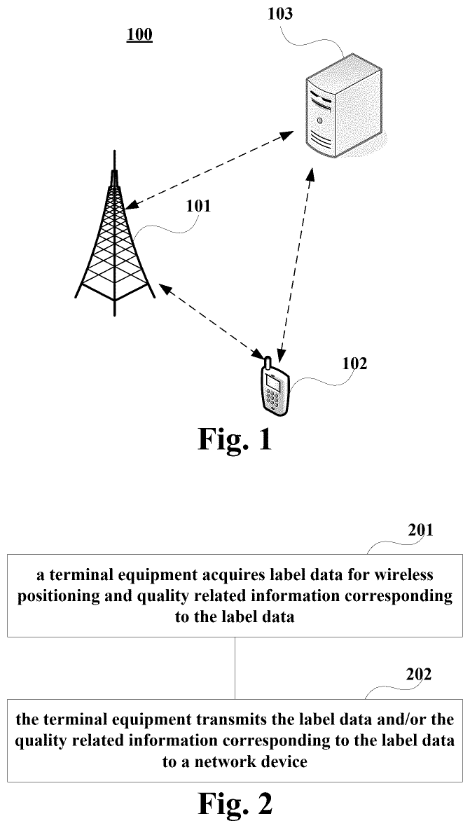

FIG. 1 is a schematic diagram illustrating a communication system according to embodiments of this disclosure, which schematically illustrates a situation in which a terminal equipment and a network device are used as an example. As illustrated in the FIG. 1, a communication system 100 may include a network device 101, a terminal equipment 102, and a location server 103. For the sake of simplicity, the FIG. 1 only illustrates one terminal equipment and one network device as an example, however, the embodiments of this disclosure are not limited thereto.

In the embodiments of this disclosure, existing services or services that may be implemented in the future may be transmitted between the network device 101 and the terminal equipment 102. For example, these services may include but are not limited to: an enhanced Mobile Broadband (eMBB), a massive Machine Type Communication (mMTC), and an Ultra-Reliable and Low Latency Communication (URLLC), etc.

It should be noted that FIG. 1 illustrates that the terminal equipment 102 is within the coverage of the network device 101, however, this disclosure is not limited thereto. The terminal equipment 102 may not be within the coverage of the network device 101. In addition, the FIG. 1 illustrates the deployment of the location server 103 alone as an example, and the AI/ML models can be run in the location server 103 to obtain a positioning result; however, this disclosure is not limited thereto. The location server 103 may be deployed in the core network, in the network device 102 (such as the base station), or in the terminal equipment 103. The embodiments of this disclosure do not limit these situations.

In the embodiments of this disclosure, the terminal equipment to be located may be referred to as a target device, and the function of the location server may be referred to as a location management function (LMF). The LMF may be a network entity for terminal location and management, and the location server with a location management function may be referred to as LMF. In the absence of confusion, the terms “LMF” and “location server” may be interchangeable. Reference may be made to the relevant technologies for the specific content of these concepts and positioning.

In the embodiments of this disclosure, the device for transmitting wireless positioning information (also referred to as an information transmission module or an information transmission entity) may be a terminal equipment (such as UE), or a network device (such as a gNB or an entity of a core network (such as LMF or AMF)), or may be part of function or entity of any of the above devices. The device for receiving wireless positioning information (also referred to as an information receiving module or an information receiving entity) may be a network device (such as a gNB or an entity of a core network (such as LMF or AMF)), or may be a terminal equipment (such as UE), or may be part of function or entity of any of the above devices. In addition, FIG. 1 illustrates wireless positioning as an example, however, this disclosure is not limited thereto. The transmission scheme of wireless positioning information of this disclosure may be applied to any other relevant scenarios.

### Embodiments of a First Aspect

The embodiments of this disclosure provide a method for transmitting wireless positioning information described from a perspective of an information transmitting device. The information transmitting device may be a terminal equipment (such as a target device, a PRU or other terminal) or a network device (such as a base station or a location server with a LMF function).

FIG. 2 is a schematic diagram illustrating a method for transmitting wireless positioning information according to embodiments of this disclosure. As illustrated in the FIG. 2, the method includes:
201, a terminal equipment acquires label data for wireless positioning and quality related information corresponding to the label data; and
202, the terminal equipment transmits the label data and/or the quality related information corresponding to the label data to a network device.

It should be noted that the FIG. 2 only schematically illustrates the embodiments of this disclosure, however, this disclosure is not limited thereto. For example, an order of execution of the operations may be appropriately adjusted, and some other operations may be added, or some operations therein may be removed. And appropriate variants may be made by those skilled in the art according to the above content, without being limited to the disclosure illustrated in the FIG. 2.

In some embodiments, the label data are used for operation and optimization of a wireless positioning model, and the quality related information is used to assist the label data in optimizing the wireless positioning model.

In the existing AI/ML model solutions for wireless positioning, absolutely accurate wireless positioning label data cannot be acquired. In addition, even if data measurements are reported, the accompanying report generally only includes: data error source information, data acquisition time information (for example, including absolute timestamp information and/or SFN frame information), etc., however, these information is insufficient to effectively supervise, retrain, and fine-tune and perform other operations on the AI/ML models.

In the embodiments of this disclosure, while or after the label data (ground truth data) are acquired, the corresponding quality related information as auxiliary information, such as mathematical statistical information, accuracy estimation information, beam information of the current label data is also acquired. These quality related information may be transmitted to a model deployment entity together with the label data via an air interface. The auxiliary information can assist the model deployment entity in making more accurate determination during training, inference or supervision, such as whether inaccurate label data samples need to be discarded or whether an appropriate model should be selected for switching and retraining after these samples are classified.

Therefore, by transmitting the label data for wireless positioning and the corresponding quality related information between the network device and the terminal equipment, the device deploying the AI/ML models can make decisions on optimization of the current model according to the quality related information of the label data even when entering an unfamiliar environment, thus the generalization of the models can be improved and the accuracy of wireless positioning of the AI/ML models can be improved.

For example, an entity with good label data quality can be selected to initiate data collection; or label data can be selected according to the quality of the current data for re-training or fine-tuning training or performance supervision; or falling back to the traditional wireless positioning methods can be selected when the data quality is poor.

In some embodiments, the terminal equipment can obtain accurate label data based on the current positioning technologies, for example, by using PRU (Positioning Reference Unit) and other positioning technologies such as GNSS, WIFI, etc. These accurate positioning resources cannot be guaranteed to be available in all environments and at all times. The terminal equipment can obtain these label data when they are available and then report the label data to the network device.

In addition, the terminal equipment can perform operations such as statistics, calculation, and screening after acquiring the label data, in order to obtain quality related information of these label data. That is, the terminal equipment can expand and enhance the content of data auxiliary information, such that the auxiliary information includes quality related information, and the information is transmitted by a data collection device (such as UE or PRU) to a model deployment device (such as a base station or a LMF) via the air interface, in order to assist the base station or LMF in performing various model-related optimizations or actions to improve the accuracy of wireless positioning.

For example, the terminal equipment can acquire the label data and obtain the corresponding quality related information through statistics, calculations, provided that conditions are met. The terminal equipment may periodically report the obtained label data and/or corresponding quality related information, or may aperiodically report the obtained label data and/or corresponding quality related information.

In some embodiments, the label data include at least one of location information, time information, angle information, line-of-sight (LOS)/non-line-of-sight (NLOS) indication information. However, this disclosure is not limited thereto. The label data may also be other data required by the AI/ML models of wireless positioning.

In some embodiments, the quality related information includes at least one of error information, error level or range information, confidence information, signal to interference plus noise ratio (SINR) information, or reference signal receiving power (RSRP) information. However, this disclosure is not limited thereto. The quality related information may also be other information, such as data source information, wireless environment information, state or statistical information, evaluation indicator information.

In some embodiments, the label data and the quality related information are obtained and reported accordingly. For example, one or more of the quality related information may be included for each of the above label data.

For example, if the label data include location information, the terminal equipment can acquire any one or more of information corresponding to the location information: error information, error level or range information, confidence information, SINR information, or RSRP information. For another example, if the label data include time information, the terminal equipment can acquire any one or more of information corresponding to the time information: error information, error level or range information, confidence information, SINR information, or RSRP information. For another example, if the label data include angle information, the terminal equipment can acquire any one or more of information corresponding to the angle information: error information, error level or range information, confidence information, SINR information, or RSRP information.

Taking the location information as an example, each UE in a wireless environment can obtain its own location information in various wireless positioning methods under suitable wireless channel conditions, and use the location information as label data. The PRU can directly obtain its own location information and use the location information as label data. In addition, the UE or PRU can calculate the quality related information of the label data. Please refer to the subsequent embodiments for specific calculation methods.

For example, when the label data are the location information and the quality related information is the error information, this can be achieved by adding a field to Common IEsProvideLocationInformation, as shown in Table 1. For example, a feedback field for the error information of the label data can be added.

TABLE 1
CommonIEsProvideLocationInformation ::= SEQUENCE {

| | | |
|---|---|---|
| locationEstimate | LocationCoordinates | OPTIONAL, |
| velocityEstimate | Velocity | OPTIONAL, |
| locationError | LocationError | OPTIONAL, |

```
  ...,
  e.g., a feedback field for the error information of the label data
  ...,
}
```

For another example, an AI/ML-specific location information IE (such as NR-DL-AI/ML-ProvideLocation Information) may also be newly defined, and the information to be fed back may be placed as a field inside the AI/ML-specific location information IE, as shown in Table 2. For example, a feedback field for the error information of the label data may be added to the AI/ML-specific location information IE.

TABLE 2
ProvideLocationInformation-r9-IEs ::= SEQUENCE {
commonIEsProvideLocationInformation

| | |
|---|---|
| | CommonIEsProvideLocationInformation OPTIONAL, |
| a-gnss-ProvideLocationInformation | A-GNSS-ProvideLocationInformation OPTIONAL, |
| otdoa-ProvideLocationInformation | OTDOA-ProvideLocationInformation OPTIONAL, |

```
  ...,
  [[ nr-ECID-ProvideLocationInformation-r16
```

NR-ECID-ProvideLocationInformation-r16

```
  OPTIONAL,
  ...,
  AI/ML-specific location information IE
  ...,
  ]]
}
AI/ML-specific location information IE
{
  ...,
  e.g., a feedback field for the error information of the label data
  ...,
}
```

The above is illustrated exemplarily with an example of IE for LPP signaling, however, this disclosure is not limited thereto.

The error information is taken as an example below for illustrative explanation. For example, the error information may be a difference between currently collected data and accurate data, in which the accurate data may be acquired by non-3GPP wireless positioning methods such as GNSS, WIFI or LIDAR, etc., or using the PRU in the current wireless environment, or by traditional positioning methods or AI/ML methods when channel conditions are good. The specific method is determined by an implementation algorithm of a data collection entity.

For example, accurate UE location data coordinate is (x, y), and currently acquired UE location data coordinate is (x1, y1), then the UE can report the following error information:
a difference (x1−x, y1−y) between exact coordinate and acquired coordinate in two dimensions is reported, respectively, whose type can be an absolute value or a relative value;
a distance between the exact coordinate and the acquired coordinate (such as Euclidean distance, Mahalanobis distance, etc.), which can be obtained by square root or other mathematical methods, is only reported; or
for three-dimensional coordinate location information, error information may be calculated separately in three dimensions, or error information in one or two dimensions may be selected for calculation.

Accordingly, when the label data are time information and/or angle information, the respective error information may also be reported. Table 3 shows an example of a feedback field as error information of the label data.

```
TABLE 3
a feedback field as error information of the label data{
  ...,
  coordinate error information mode (optionally, 2D or 3D or distance),
  coordinate error information type (optionally, absolute or relative
  value),
  X-axis error data,
  Y-axis error data,
  Z-axis error data,
  time error information,
  angle error information
  ...,
}
```

The corresponding error or difference information can also be provided for the collected label data that are non-location coordinate information. For example, an accurate value for probability information of LOS/NLOS is X %, and a currently collected value is X1%, then the error information may be defined as (X−X1) %.

The error level or error range is taken below as an example for illustrative explanation. For example, the error information may not be accurately calculated by the device, and a roughly estimated error value, i.e., the error range or error level, may only be obtained.

For example, the UE may feed an approximate error range of the data back to the LMF via signaling (such as LPP). When the data are the location information, the error range may be characterized as a numerical value range characterized in units of length such as meters (m) or centimeters (cm), such as an error range of 0.5 m, 10 cm, etc., and may be quantified into some common options, such as an interval of 1 meter. When the data are time information (such as TDOA, RSTD), a time unit can be used as an interval; and when the data are angle information, the data can be processed similarly.

Table 4 shows an example of a feedback field as an error range of the label data.

TABLE 4
a feedback field as an error range of the label data
...,

| | |
|---|---|
| coordinate error range information | ENUMERATED{minimum error range (e.g, |

1m), ..., maximum error range}

| | |
|---|---|
| time error range information | ENUMERATED{minimum error range (e.g, |

1s), ..., maximum error range}

| | |
|---|---|
| angle error range information | ENUMERATED{minimum error range (e.g, |

1RAD), ..., maximum error range}
...,
}

For another example, the UE may feed the error level back to the LMF via signaling (such as LPP). For example, the error values of different levels are quantified and represented by numbers (such as level 1, level 2 . . . ) or characters with representative meanings (such as good, medium, bad, etc.). The specific error range corresponding to the error level or the impact on the subsequent process may be determined by the specific implementation technology.

Table 5 shows an example of a feedback field as an error level of the label data.

TABLE 5
a feedback field as an error level of the label data{
...,

| | |
|---|---|
| coordinate error level information | ENUMERATED{minimum level, level 2, |

level 3., maximum level} (the minimum level corresponds to the minimum error range)

| | |
|---|---|
| time error level information | ENUMERATED{minimum level, level 2, level |

3., maximum level} (the minimum level corresponds to the minimum error range)

| | |
|---|---|
| angle error level information | ENUMERATED{minimum level, level 2, level |

3., maximum level} (the minimum level corresponds to the minimum error range)
...,
}

As for a case where the quality related information is confidence information, for example, the confidence information can feed back a probability distribution of current data quality, for example, the current data quality information may be estimated by calculating the probability through statistics on a plurality of historical data quality information. Please refer to the relevant technologies for specific calculation methods.

As for a case where the quality related information is SINR information, for example, the UE or PRU may feed data SINR information back to the LMF via signaling (such as LPP). The specific calculation method of SINR may be implemented by the UE through channel measurement and its own algorithm. When reporting to the LMF, one may choose to report the respective SINR value for each data, or may report only one SINR value for a plurality of data within one reporting period.

Table 6 shows another example of a feedback field as an error level of the label data, which shows a case of SINR.

```
TABLE 6
a feedback field as an error level of the label data{
  ...,
    SINR value corresponding to the current data
    reported granularity of the SINR value (optionally, whole cycle,
    individual data, etc.)
    ...,
}
```

As for a case where the quality related information is RSRP information, for example, the UE or PRU may feed data RSRP information back to the LMF via signaling (such as LPP). The UE or PRU may perform a channel measurement on a reference signal used to acquire the label data, in order to acquire the corresponding RSRP information.

Table 7 shows another example of a feedback field as an error level of the label data, which shows a case of RSRP.

TABLE 7

```
a feedback field as an error level of the label data{
  ...,
  RSRP value corresponding to the current data
    ...,
}
```

Direct information, which reflects the quality of the label data, is exemplarily illustrated above, and indirect information, which reflects the quality of the label data, is exemplarily illustrated below.

In some embodiments, the label data include location information, and the quality related information corresponding to the label data includes: information on a source of the label data, and/or information on a wireless environment where the terminal equipment is located when the label data are acquired.

For example, in addition to the quality related information mentioned above, the terminal equipment may also acquire data source information, wireless environment information, etc. For example, the UE can obtain its own location information by various wireless positioning methods, and use the location information as the label data, then the information on the source of the label data (such as an identifier of the adopted positioning method) may be used as the quality related information. For another example, the UE can obtain its own location information through WIFI, and use the location information as the label data, then environment-related information, such as a WIFI scene, an area, a beam, etc., may be used as the quality related information.

For example, the UE may collect and report the data source information. Table 8 exemplarily shows an example of the data source information using location information as an example.

TABLE 8

| | | |
|---|---|---|
| LocationSource-r13 ::= BIT STRING { | a-gnss | (0), |

| | |
|---|---|
| wlan | (1), |
| bt | (2), |
| tbs | (3), |
| sensor | (4), |
| ha-gnss-v1510 | (5), |
| motion-sensor-v1550 | (6), |
| dl-tdoa-r16 | (7), |
| dl-aod-r16 | (8) |

```
  PRU type 1
  PRU type 2
  ...,
  traditional positioning method XX
  AI/ML method
  other method
  ...,
```

} (SIZE(1..XX))

As shown in Table 8, the data source information such as a PRU type, a traditional positioning method, an AI/ML method may be added.

For another example, in a wireless channel environment used for positioning, based on differences in geographical location, channel characteristics, some related information such as a geographical area, a scene, a beam, etc., may be generated, and may be classified and distinguished with identification information (such as a scene ID, a beam ID, an area ID, a NLOS level ID, etc.); these auxiliary information may be transmitted to the LMF by the UE via LPP signaling together with the data, as part of the quality related information to determine whether the current data are available and how to use the information.

Table 9 shows an example of auxiliary information.

TABLE 9

```
a feedback field as auxiliary information of the label data{
  ...,
  scene ID corresponding to the data
  area ID corresponding to the data
  beam ID corresponding to the data
  NLOS Level ID corresponding to the data
  other information related to the AI/ML model environment
  ...,
}
```

The above information may be carried via “ProvideLocationInformation” of the LPP signaling, or via “ProvideAssistanceData” of the LPP signaling, or via other LPP signaling or non-LPP signaling. This disclosure is not limited thereto.

In some embodiments, the label data include LOS/NLOS indication information, and the quality related information corresponding to the label data includes: configuration information for calculating LOS/NLOS state or statistical information (such as probability) of a wireless channel between the network device and the terminal equipment, and/or evaluation indicator information. For example, the evaluation indicator information includes: calculation accuracy information, processing speed information and/or calculation complexity information.

For example, in addition to the quality related information mentioned above, the terminal equipment may also acquire state information or statistical information, evaluation indicator information, etc. For example, the UE may calculate the LOS/NLOS indication information, such as LOS/NLOS probability information; use LOS/NLOS probability as the label data, then information related to an implementation algorithm for calculating the LOS/NLOS probability is used as the quality related information.

The LOS/NLOS probability may also be used as label data for a type of AI/ML model, and an acquisition of this type of data depends on an algorithm used for entity calculation to a great extent. The UE can transmit information about the algorithm used in LOS/NLOS calculation to the LMF via LPP signaling, and different algorithms may correspond to different data accuracies.

For example, the network device and the terminal equipment agree on a list of supportable LOS/NLOS probability calculation methods and define respective indexes. Different algorithms or different implementation s correspond to different indexes and data quality/applicability. When reporting data, the terminal equipment may choose to report the indexes together.

For another example, the network device may define some specific evaluation indicators related to algorithms, such as algorithm module processing speed, computational complexity, etc. The terminal equipment may choose to transmit the evaluation indicator information to the network device, and the network device may comprehensively determine a correspondence between a current algorithm and the data quality/applicability.

In some embodiments, the terminal equipment may acquire respective quality related information for each label data, however, this disclosure is not limited thereto. In some embodiments, the terminal equipment acquires and transmits the quality related information corresponding to a plurality of label data for the plurality of label data.

For example, the terminal equipment performs statistics on all or part of the label data within a period of time to obtain the quality related information corresponding to the whole label data (all or part of the label data). These label data may be data obtained continuously during this period of time, or may be some filtered discrete data, etc. This disclosure is not limited thereto.

In some embodiments, the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

Therefore, reporting the quality related information corresponding to the plurality of label data can not only improve the accuracy of wireless positioning, but also reduce the amount of reported data and further reduce the air interface transmission overhead.

For example, since the total amount of AI/ML data is usually large, especially in the model training stage, if the quality related information is attached to each set of label data, reporting may consume too much uplink resources. Therefore, the overall error information of an entire batch of data collected within a period of time may be reported in a unified manner.

For example, the reported content may be at least one of
minimum or maximum error range information;
maximum error information, minimum error information, average error information, or median error value information within the overall sample;
overall error confidence information indicative of the overall error statistical information of samples; for example, an error threshold may be set, and a percentage of samples smaller than the error threshold to a total number of samples may be counted to reflect the confidence information of the overall data.

Table 10 shows an example of a feedback field as a batch error level of the label data.

TABLE 10

```
a feedback field as a batch error level of the label data{
  ...,
  batch error level information XXX
      ...,
}
batch error level information
{
  ...,
  time information (start and end time for collecting batch data)
  quantity information (number of batches of data)
  error information
    error confidence information
  ...,
}
```

In some embodiments, the terminal equipment receives indication information from the network device; and the terminal equipment transmits the label data and/or the quality related information corresponding to the label data to the network device according to the indication information.

Therefore, when receiving the indication information from the network device, the terminal equipment may report the label data and/or the quality related information as needed, thereby reducing the amount of reported data and further reducing the air interface transmission overhead while improving the accuracy of wireless positioning.

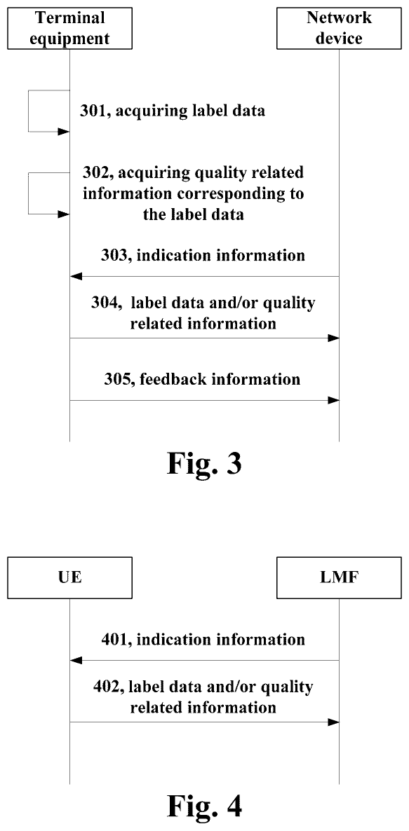

FIG. 3 is another schematic diagram illustrating a method for transmitting wireless positioning information according to embodiments of this disclosure. As illustrated in the FIG. 3, the method includes:
301, a terminal equipment acquires label data for wireless positioning;
302, the terminal equipment acquires (calculate, count, screen, and so on) quality related information corresponding to the label data;
303, the terminal equipment receives indication information from a network device; and
304, the terminal equipment transmits the label data and/or the quality related information corresponding to the label data to the network device according to the indication information.

It should be noted that the FIG. 3 only schematically illustrates the embodiments of this disclosure, however, this disclosure is not limited thereto. For example, an order of execution among the operations may be appropriately adjusted, other operations may be added, or some operations therein may be removed. And appropriate variants may be made by those skilled in the art based on the above contents, without being limited to the disclosure illustrated in the FIG. 3.

In some embodiments, the terminal equipment may transmit the label data and the quality related information together according to the indication information; or the terminal equipment may first transmit the label data and then transmit the quality related information according to the indication information; or the terminal equipment may first transmit the quality related information and then transmit the label data according to the indication information; or the terminal equipment may transmit the label data according to the indication information (for example, the corresponding quality related information is not transmitted in this transmission); or the terminal equipment may transmit the quality related information according to the indication information (for example, the corresponding label data are not transmitted in this transmission).

In some embodiments, the indication information indicates content, range or format of the quality related information; this disclosure is not limited thereto. In addition, the indication information includes threshold information and/or counting information and/or time information for selecting the label data and/or the quality related information. After receiving the indication information, the terminal equipment may prepare the label data and/or the quality related information according to requirements of the indication information and report the label data and/or the quality related information to the network device.

As illustrated in the FIG. 3, the method may further include:
305, the terminal equipment transmits feedback information to the network device.

For example, the feedback information includes at least one of transmission completion confirmation information, transmission incompletion confirmation information, transmission incompletion reason information, or retransmission request information; this disclosure is not limited thereto.

The indication information is further exemplified below. For example, the network device (such as LMF) may also screen the data quality when reporting the indication data, e.g., specifying some quality thresholds or timers. Various quality related information, such as a data maximum error threshold, a maximum error level threshold, a batch data maximum error rate threshold, etc., given in the embodiments may be included. For another example, the network device may also specify information such as the data source, scene ID, area ID, NLOS level ID, beam ID corresponding to the data expected to be acquired.

In some examples, the network device may directly specify a specific threshold value for data quality related information, e.g., specify that a maximum error value of 2D position coordinates shall not exceed 1 meter, or a maximum error level shall not exceed a third level. The specific definition depends on the specific implementation method.

In some examples, the network device may also control a sample size of data that meets quality information by way of setting a counter. For example, if a minimum sample size is set to 1,000, the terminal equipment may collect at least 1,000 samples that meet the required data quality before reporting.

In some examples, the network device can also control a time period for collecting information by way of setting a timer. For example, if the timer is set to 5 ms, data collected beyond 5 ms may not be reported.

The threshold information, timer, and counter may be used in combination or separately.

In some examples, the network device may also define subsequent actions for the terminal equipment when data requirements cannot be met at the same time, for example, the terminal equipment is required to discard data that do not meet quality requirements, re-collect data, or further screen the data based on given additional information.

In some examples, after receiving the indication information given by the network device, the terminal equipment may provide information feedback to the network device, and the feedback content may include transmission completion/incompletion confirmation information of data and auxiliary information, additional reason information of transmission incompletion.

The network device may carry the above information via existing LPP signaling, newly defined LPP signaling or other signaling. The following IE provides an example of using “CommonIEsRequestLocationInformation” IE in the existing LPP signaling for carrying information.

TABLE 11
CommonIEsRequestLocationInformation ::= SEQUENCE {

| locationInformationType | LocationInformationType, | |
|---|---|---|
| triggeredReporting | TriggeredReportingCriteria | OPTIONAL, -- Cond ECID |
| periodicalReporting | PeriodicalReportingCriteria | OPTIONAL, -- Need ON |
| additionalInformation | AdditionalInformation | OPTIONAL, -- Need |

ON

| | | |
|---|---|---|
| qos | QoS c | OPTIONAL, -- Need ON |
| environment | Environment | OPTIONAL, -- Need ON |
| locationCoordinateTypes | LocationCoordinateTypes | OPTIONAL, -- Need ON |
| velocityTypes | VelocityTypes | OPTIONAL, -- Need ON |

```
  ...,
  [[
```

| | |
|---|---|
| messageSizeLimitNB-r14MessageSizeLimitNB-r14 | OPTIONAL -- Need ON |

```
  ]],
  [[
```

| | |
|---|---|
| segmentationInfo-r14SegmentationInfo-r14 | OPTIONAL -- Need ON |

```
  ]],
  [[
      scheduledLocationRequest-r17
```

ScheduledLocationRequest-r17

OPTIONAL, -- Need ON

integrityInformationRequest-r17

IntegrityInformationRequest-r17

OPTIONAL -- Need ON

```
    ...,
  various data quality threshold information
  ]]
}
```

The label data and/or the quality related information are schematically explained above, and some examples are given below.

FIG. 4 is an example diagram illustrating transmission of label data and/or quality related information between a UE and a LMF according to embodiments of this disclosure. As illustrated in the FIG. 4, the LMF transmits to the UE indication information (401) to instruct the UE to transmit label data and/or quality related information; and the UE reports the label data and/or the quality related information (402) according to the indication information.

For example, the LMF indicates the label data and/or the quality related information to the UE via an IE of LPP signaling, such as “RequestLocationInformation”. The UE transmits the label data and/or the quality related information to the LMF via an IE of LPP signaling, such as “ProvideLocationInformation”.

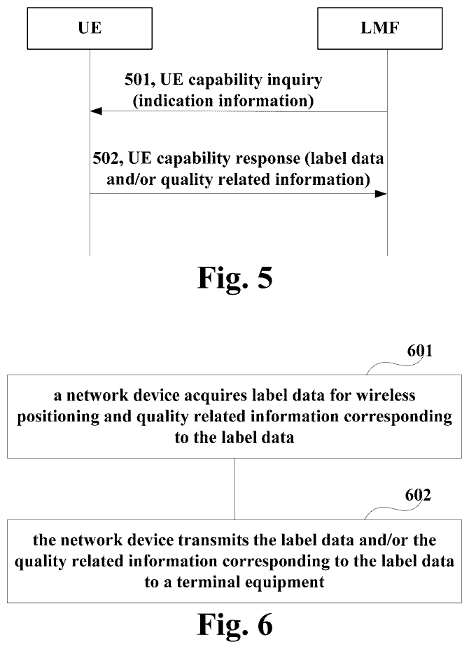

FIG. 5 is another example diagram illustrating transmission of label data and/or quality related information between a UE and a LMF according to embodiments of this disclosure. As illustrated in the FIG. 5, the LMF initiates a UE capability inquiry (501) to the UE, and the UE reports the label data and/or the quality related information through a UE capability response (502).

In addition, the label data may also be interacted and reported via other LPP signaling (such as AssistanceData) or may also be interacted and reported via other air interface signaling, such as RRC or NRPPa, etc., when the data are the location information.

The reported label data may be interacted and reported via existing auxiliary information LPP signaling (such as AssistanceData), or via other LPP signaling, or via newly defined LPP signaling or other signaling (such as RRC, NRPPa), if the data are other non-location information, such as channel LOS/NLOS information.

It should be noted that the FIGS. 4 and 5 only schematically illustrate the embodiments of this disclosure, however, this disclosure is not limited thereto. For example, an order of execution of the operations may be appropriately adjusted, other operations may be added, or some operations therein may be removed. And appropriate variants may be made by those skilled in the art based on the above content, without being limited to the disclosure illustrated in the FIGS. 4 and 5.

The description is made above by taking the information transmitting device as the terminal equipment and the information receiving device as the network device as an example, however, this disclosure is not limited thereto. The description will be made below by taking the information transmitting device as the network device and the information receiving device as the terminal equipment. The same contents as above will be omitted.

FIG. 6 is another schematic diagram illustrating a method for transmitting wireless positioning information according to embodiments of this disclosure. As illustrated in the FIG. 6, the method includes:
601, a network device acquires label data for wireless positioning and quality related information corresponding to the label data; and
602, the network device transmits the label data and/or the quality related information corresponding to the label data to a terminal equipment.

It should be noted that the FIG. 6 only schematically illustrates the embodiments of this disclosure, however, this disclosure is not limited thereto. For example, an order of execution of the operations may be appropriately adjusted, and other operations may be added or some operations therein may be removed. And appropriate variants may be made by those skilled in the art according to the above content, without being limited to the disclosure illustrated in the FIG. 6.

In some embodiments, the label data are used for operation and optimization of a wireless positioning model, and the quality related information is used to assist the label data in optimizing the wireless positioning model.

In some embodiments, the label data include at least one of location information, time information, angle information, or line-of-sight (LOS)/non-line-of-sight (NLOS) indication information.

In some embodiments, the quality related information includes at least one of error information, error level or range information, confidence information, signal to interference plus noise ratio (SINR) information, or reference signal receiving power (RSRP) information.

In some embodiments, the label data include location information, and the quality related information corresponding to the label data includes: information on a source of the label data and/or information on a wireless environment where the terminal equipment is located when the label data are acquired.

In some embodiments, the label data include LOS/NLOS indication information, and the quality related information corresponding to the label data includes: configuration information and/or evaluation indicator information for calculating LOS/NLOS state or statistical information (such as probability) of a wireless channel between the network device and the terminal equipment.

In some embodiments, the evaluation indicator information includes: calculation accuracy information, processing speed information and/or calculation complexity information.

In some embodiments, the network device acquires and transmits quality related information corresponding to a plurality of label data within a period of time for the plurality of label data.

In some embodiments, the network device performs statistics on all or part of the label data within the period of time to obtain corresponding quality related information.

In some embodiments, the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

In some embodiments, the network device receives request information from the terminal equipment; and the network device transmits the label data and/or the quality related information corresponding to the label data to the terminal equipment according to the request information.

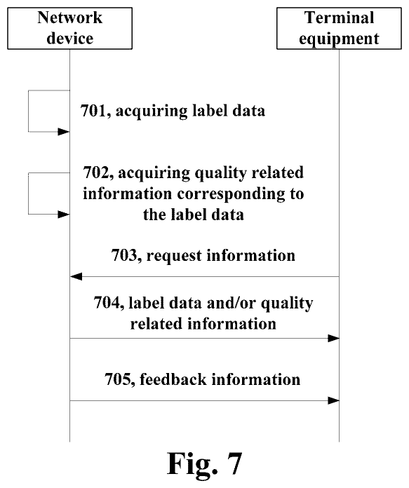

FIG. 7 is another schematic diagram illustrating a method for transmitting wireless positioning information according to embodiments of this disclosure. As illustrated in the FIG. 7, the method includes:
701, a network device acquires label data for wireless positioning;
702, the network device acquires (calculate, count, screen, and so on) quality related information corresponding to the label data;
703, the network device receives request information from a terminal equipment; and
704, the network device transmits the label data and/or the quality related information corresponding to the label data to the terminal equipment according to the request information. It should be noted that the FIG. 7 only schematically illustrates the embodiments of this disclosure, however, this disclosure is not limited thereto. For example, an order of execution of the operations may be appropriately adjusted, and other operations may be added, or some operations therein may be removed. And appropriate variants may be made by those skilled in the art according to the above content, without being limited to the disclosure illustrated in the FIG. 7.

In some embodiments, as illustrated in the FIG. 7, the method may further include:
705, the network device transmits feedback information to the terminal equipment.

In some embodiments, the network device transmits the label data and the quality related information together according to the request information; or the network device first transmits the label data and then transmits the quality related information according to the request information; or the network device first transmits the quality related information and then transmits the label data according to the request information; or the network device transmits the label data according to the request information; or the network device transmits the quality related information according to the request information.

In some embodiments, the request information indicates content, range or format of the quality related information.

In some embodiments, the request information includes threshold information and/or counting information and/or time information for selecting the label data and/or the quality related information.

In some embodiments, the network device transmits feedback information to the terminal equipment.

In some embodiments, the feedback information includes at least one of transmission completion confirmation information, transmission incompletion confirmation information, transmission incompletion reason information, or retransmission request information.

The above embodiments only schematically illustrate this disclosure, however, this disclosure is not limited thereto, and appropriate variants may be made on the basis of the above embodiments. For example, the above embodiments may be executed separately, or one or more of the above embodiments may be executed in a combined manner.

According to the embodiments of this disclosure, by transmitting the label data for wireless positioning and the corresponding quality related information between the network device and the terminal equipment, the device deploying the AI/ML models can make decisions on optimization of the current model according to the quality related information of the label data even when entering the unfamiliar environment, thus the generalization of the models can be improved and the accuracy of wireless positioning of the AI/ML models can be improved.

### Embodiments of a Second Aspect

The embodiments of this disclosure provide a method for receiving wireless positioning information described from a perspective of an information receiving device. The embodiments of the second aspect correspond to those of the first aspect. The same contents will not be described anymore.

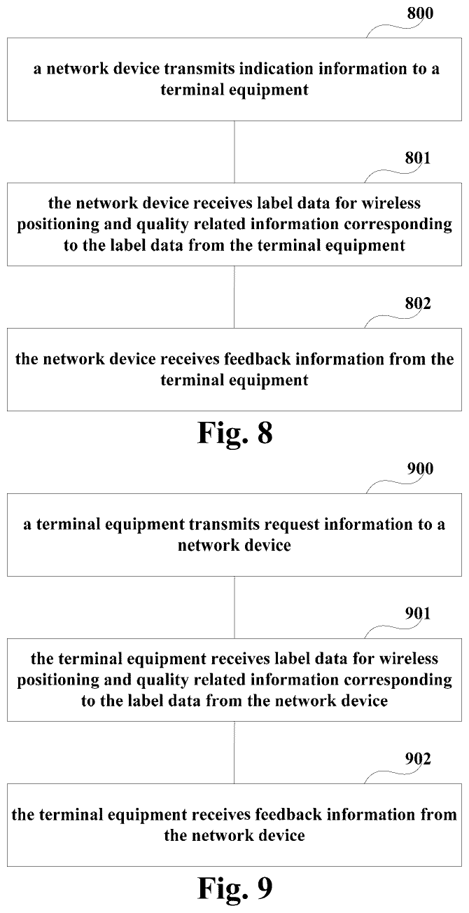

FIG. 8 is a schematic diagram illustrating a method for receiving information according to embodiments of this disclosure. As illustrated in the FIG. 8, the method includes:
801, a network device receives label data for wireless positioning and quality related information corresponding to the label data from the terminal equipment.

In some embodiments, as illustrated in the FIG. 8, the method further includes:
800, the network device transmits indication information to a terminal equipment; and the terminal equipment transmits the label data and/or the quality related information corresponding to the label data to the network device according to the indication information.

In some embodiments, as illustrated in the FIG. 8, the method further includes:
802, the network device receives feedback information from the terminal equipment.

It should be noted that the FIG. 8 only schematically illustrates the embodiments of this disclosure, however, this disclosure is not limited thereto. For example, an order of execution of the operations may be appropriately adjusted, and other operations may be added, or some operations therein may be removed. And appropriate variants may be made by those skilled in the art according to the above content, without being limited to the disclosure illustrated in the FIG. 8.

The description is made above by taking the information transmitting device as the terminal equipment and the information receiving device as the network device as an example, however, this disclosure is not limited thereto. The description will be made below by taking the information transmitting device as the network device and the information receiving device as the terminal equipment. The same contents as above will be omitted.

FIG. 9 is another schematic diagram illustrating a method for receiving information according to embodiments of this disclosure. As illustrated in the FIG. 9, the method includes:
901, a terminal equipment receives label data for wireless positioning and quality related information corresponding to the label data from the network device.

In some embodiments, as illustrated in the FIG. 9, the method further includes:
900, the terminal equipment transmits request information to a network device; and the terminal equipment transmits the label data and/or the quality related information corresponding to the label data to the network device according to the request information.

In some embodiments, as illustrated in the FIG. 9, the method further includes:
902, the terminal equipment receives feedback information from the network device.

The above embodiments only schematically illustrate this disclosure, however, this disclosure is not limited thereto, and appropriate variants may be made on the basis of the above embodiments. For example, the above embodiments may be executed separately, or one or more of the above embodiments may be executed in a combined manner.

According to the embodiments of this disclosure, by transmitting the label data for wireless positioning and the corresponding quality related information between the network device and the terminal equipment, the device deploying the AI/ML models can make decisions on optimization of the current model according to the quality related information of the label data even when entering the unfamiliar environment, thus the generalization of the models can be improved and the accuracy of wireless positioning of the AI/ML models can be improved.

### Embodiments of a Third Aspect

The embodiments of this disclosure provide a wireless positioning information transmitting device (information transmitting device). Since the function of the information transmitting device to solve the problem is the same as that of the method in the embodiments of the first aspect, the embodiments of the first aspect may be referred to for specific implementation. The same contents will not be described anymore.

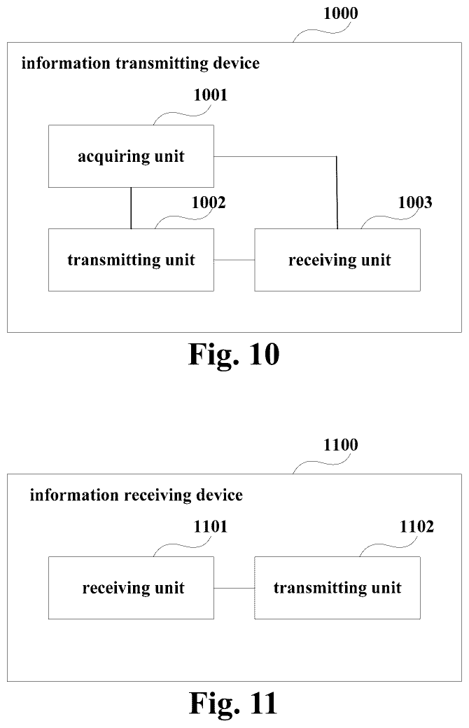

FIG. 10 is a schematic diagram illustrating an information transmitting device according to embodiments of this disclosure, in which the information transmitting device may be configured in a terminal equipment or a network device. As illustrated in the FIG. 10, an information transmitting device 1000 includes:
an acquiring unit 1001 configured to acquire label data for wireless positioning and quality related information corresponding to the label data; and
a transmitting unit 1002 configured to transmit the label data and/or the quality related information corresponding to the label data.

It should be noted that the FIG. 10 only schematically illustrates the embodiments of this disclosure, however, this disclosure is not limited thereto. For example, other modules or components may be appropriately added or some modules or components therein may be removed. And appropriate variants may be made by those skilled in the art according to the above content, without being limited to the disclosure illustrated in the FIG. 10.

In some embodiments, the label data are used for operation and optimization of a wireless positioning model, and the quality related information is used to assist the label data in optimizing the wireless positioning model.

In some embodiments, the label data include at least one of location information, time information, angle information, or line-of-sight (LOS)/non-line-of-sight (NLOS) indication information.

In some embodiments, the quality related information includes at least one of error information, error level or range information, confidence information, signal to interference plus noise ratio (SINR) information, or reference signal receiving power (RSRP) information.

In some embodiments, the label data include location information, and the quality related information corresponding to the label data includes: information on a source of the label data and/or information on a wireless environment when the label data are acquired.

In some embodiments, the label data include LOS/NLOS indication information, and the quality related information corresponding to the label data includes: configuration information and/or evaluation indicator information for calculating LOS/NLOS state or statistical information of a wireless channel between the network device and the terminal equipment.

In some embodiments, the evaluation indicator information includes: calculation accuracy information, processing speed information and/or calculation complexity information.

In some embodiments, quality related information corresponding to a plurality of label data is acquired and transmitted for the plurality of label data within a period of time.

In some embodiments, statistics are performed on all or part of the label data within the period of time to obtain the corresponding quality related information.

In some embodiments, the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

In some embodiments, as illustrated in the FIG. 10, the device may further include:
a receiving unit 1003 configured to receive request information or indication information.

Furthermore, the transmitting unit 1002 transmits the label data and/or the quality related information corresponding to the label data according to the request information or the indication information.

In some embodiments, the transmitting unit 1002 transmits the label data and the quality related information together according to the request information or the indication information; or first transmits the label data and then transmits the quality related information according to the request information or the indication information; or first transmits the quality related information and then transmits the label data according to the request information or the indication information; or transmits the label data according to the request information or the indication information; or transmits the quality related information according to the request information.

In some embodiments, the request information or the indication information indicates content, range or format of the quality related information.

In some embodiments, the request information or the indication information includes threshold information and/or counting information and/or time information for selecting the label data and/or the quality related information.

In some embodiments, the transmitting unit 1002 also transmits feedback information.

In some embodiments, the feedback information includes at least one of transmission completion confirmation information, transmission incompletion confirmation information, transmission incompletion reason information, or retransmission request information.

In addition, for the sake of simplicity, connection relationships between components or modules or signal profiles thereof are only exemplarily illustrated in the FIG. 10. However, it should be clear to those skilled in the art that various related technologies such as bus connection, etc., may be adopted. And the above components or modules may be implemented by hardware, such as a processor, a memory, a transmitter, and a receiver, etc., however, this disclosure is not limited thereto.

The above embodiments only schematically illustrate this disclosure, however, this disclosure is not limited thereto, and appropriate variants may be made on the basis of the above embodiments. For example, the above embodiments may be executed separately, or one or more of the above embodiments may be executed in a combined manner.

According to the embodiments of this disclosure, by transmitting the label data for wireless positioning and the corresponding quality related information between the network device and the terminal equipment, the device deploying the AI/ML models can make decisions on optimization of the current model according to the quality related information of the label data even when entering the unfamiliar environment, thus the generalization of the models can be improved and the accuracy of wireless positioning of the AI/ML models can be improved.

### Embodiments of a Fourth Aspect

The embodiments of this disclosure provide a wireless positioning information receiving device (information receiving device). Since the function of the information receiving device to solve the problem is the same as that of the method in the embodiments of the second aspect, the embodiments of the first and second aspects may be referred to for specific implementation. The same contents will not be described anymore.

FIG. 11 is a schematic diagram illustrating an information receiving device according to embodiments of this disclosure, in which the information receiving device may be configured in a terminal equipment or a network device. As illustrated in the FIG. 11, an information receiving device 1100 includes:
a receiving unit 1101 configured to receive label data for wireless positioning and quality related information corresponding to the label data.

It should be noted that the FIG. 11 only schematically illustrates the embodiments of this disclosure, however, this disclosure is not limited thereto. For example, other modules or components may be appropriately added or some modules or components therein may be removed. And appropriate variants may be made by those skilled in the art according to the above content, without being limited to the disclosure illustrated in the FIG. 11.

In some embodiments, as illustrated in the FIG. 11, the information receiving device 1100 further includes:
a transmitting unit 1102 configured to transmit request information or indication information.

In some embodiments, the receiving unit 1101 further receives feedback information.

In addition, for the sake of simplicity, connection relationships between components or modules or signal profiles thereof are only exemplarily illustrated in the FIG. 11. However, it should be clear to those skilled in the art that various related technologies such as bus connection, etc., may be adopted. And the above components or modules may be implemented by hardware, such as a processor, a memory, a transmitter, and a receiver, etc., however, this disclosure is not limited thereto.

The above embodiments only illustrate this disclosure, however, this disclosure is not limited thereto, and appropriate variants may be made on the basis of the above embodiments. For example, the above embodiments may be executed separately, or one or more of the above embodiments may be executed in a combined manner.

According to the embodiments of this disclosure, by transmitting the label data for wireless positioning and the corresponding quality related information between the network device and the terminal equipment, the device deploying the AI/ML models can make decisions on optimization of the current model according to the quality related information of the label data even when entering the unfamiliar environment, thus the generalization of the models can be improved and the accuracy of wireless positioning of the AI/ML models can be improved.

### Embodiments of a Fifth Aspect

The embodiments of this disclosure provide a communication system. FIG. 1 is a schematic diagram illustrating a communication system according to embodiments of this disclosure. As illustrated in the FIG. 1, the communication system 100 includes a network device 101, a terminal equipment 102, and a location server 103. For the sake of simplicity, the FIG. 1 only illustrates one network device and one terminal equipment as an example, however, the embodiment of this disclosure is not limited thereto.

In some embodiments, the communication system includes:
a terminal equipment configured to acquire label data for wireless positioning and quality related information corresponding to the label data; and transmit the label data and/or the quality related information corresponding to the label data to a network device; and
the network device configured to receive the label data and the quality related information corresponding to the label data.

In some embodiments, the communication system includes:
a network device configured to acquire label data for wireless positioning and quality related information corresponding to the label data; and transmit the label data and/or the quality related information corresponding to the label data to a terminal equipment; and
the terminal equipment configured to receive the label data and the quality related information corresponding to the label data.

An embodiment of this disclosure further provides an electronic device, which includes, for example, the aforementioned information transmitting device or information receiving device.

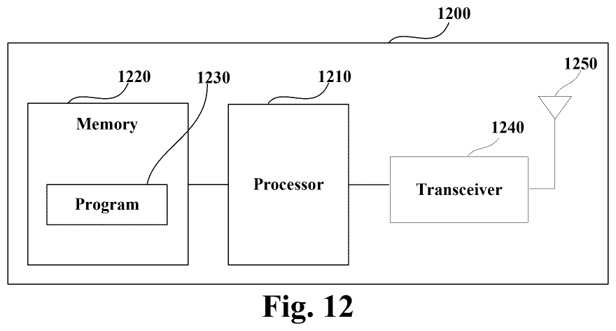

FIG. 12 is a schematic diagram illustrating an electronic device according to embodiments of this disclosure. As illustrated in the FIG. 12, an electronic device 1200 may include: a processor 1210 (e.g., a central processing unit CPU) and a memory 1220 coupled to the processor 1210. The memory 1220 may store various data. In addition, the memory 1220 may store a program 1230 for information processing, and the program 1230 may be executed under the control of the processor 1210.

For example, the processor 1210 may be configured to execute a program to implement the method for transmitting wireless positioning information in the embodiments of the first aspect. For example, the processor 1210 may be configured to acquire label data for wireless positioning and quality related information corresponding to the label data; and transmit the label data and/or the quality related information corresponding to the label data.

For another example, the processor 1210 may be configured to execute a program to implement the method for receiving wireless positioning information in the embodiments of the second aspect. For example, the processor 1210 may be configured to receive label data for wireless positioning and quality related information corresponding to the label data.

In addition, as illustrated in the FIG. 12, the electronic device 1200 may further include: a transceiver 1240 and an antenna 1250, in which functions of the components are similar to those in the relevant art, and are not described herein anymore. It should be noted that the electronic device 1200 does not necessarily include all the components illustrated in the FIG. 12, and furthermore, the electronic device 1200 may also include components not illustrated in the FIG. 12, and the relevant art may be referred to.

An embodiment of this disclosure also provides a computer readable program, which, when executed in an information transmitting device, enables a computer to implement the method for transmitting wireless positioning information in the embodiments of the first aspect in the information transmitting device.

An embodiment of this disclosure also provides a storage medium storing a computer readable program, which enables a computer to implement the method for transmitting wireless positioning information in the embodiments of the first aspect in the information transmitting device.

An embodiment of this disclosure also provides a computer readable program, which, when executed in an information receiving device, enables a computer to implement the method for receiving wireless positioning information in the embodiments of the second aspect in the information receiving device.

An embodiment of this disclosure also provides a storage medium storing a computer readable program, which enables a computer to implement the method for receiving wireless positioning information in the embodiments of the second aspect in the information receiving device.

The above devices and methods of this disclosure may be implemented by hardware, or by hardware in combination with software. This disclosure relates to such a computer readable program, which, when executed by a logic component, enables the logic component to implement the devices or components, or enables the logic component to implement the methods or steps as described above. The logic component is, for example, a field programmable logic component, a microprocessor, a processor used in a computer. This disclosure also relates to a storage medium for storing the above program, such as a hard disk, a magnetic disk, an optical disk, a DVD, a flash memory.

The method/device described with reference to the embodiments of this disclosure may be directly embodied as hardware, a software module executed by a processor, or a combination thereof. For example, one or more functional block diagrams and/or one or more combinations of the functional block diagrams illustrated in the drawings may either correspond to software modules of procedures of a computer program, or correspond to hardware modules. Such software modules may correspond to the steps illustrated in the drawings, respectively. And these hardware modules, for example, may be implemented by firming these software modules by using a field programmable gate array (FPGA).

The software modules may be located in an RAM memory, a flash memory, an ROM memory, an EPROM memory, an EEPROM memory, a register, a hard disc, a floppy disc, a CD-ROM, or any memory medium in other forms known in the art. A memory medium may be coupled to a processor, so that the processor can read information from the memory medium, and write information into the memory medium; or the memory medium may be a component of the processor. The processor and the memory medium may be located in an ASIC. The software modules may be stored in a memory of a mobile terminal or may also be stored in a memory card of a pluggable mobile terminal. For example, if a device (such as a mobile terminal) employs an MEGA-SIM card of a large capacity or a flash memory device of a large capacity, the software modules may be stored in the MEGA-SIM card or the flash memory device of a large capacity.

One or more functional blocks and/or one or more combinations of the functional blocks in the drawings may be implemented as a general-purpose processor, a digital signal processor (DSP), an application-specific integrated circuit (ASIC), a field programmable gate array (FPGA) or other programmable logic devices, discrete gate or transistor logic devices, discrete hardware component or any appropriate combination thereof for performing the functions described in this application. And the one or more functional blocks and/or one or more combinations of the functional blocks in the drawings may also be realized as a combination of computing devices, such as a combination of a DSP and a microprocessor, a plurality of microprocessors, one or more microprocessors in communication with a DSP, or any other such configuration.

This disclosure is described above with reference to particular embodiments. However, it should be clear to those skilled in the art that these descriptions are illustrative and are not intended to limit the protection scope of this disclosure. Various variations and amendments to this disclosure may be made by those skilled in the art according to the spirit and principles of this disclosure, and such variations and amendments fall within the scope of this disclosure.

As to implementations containing the above embodiments, following supplements are further disclosed:

1. A method for transmitting wireless positioning information, including:
acquiring, by a terminal equipment, label data for wireless positioning and quality related information corresponding to the label data; and
transmitting, by the terminal equipment, the label data and/or the quality related information corresponding to the label data to a network device.

2. The method according to supplement 1, wherein the label data are used for operation and optimization of a wireless positioning model, and the quality related information is used to assist the label data in optimizing the wireless positioning model.

3. The method according to supplement 1, wherein the label data include at least one of: location information, time information, angle information, or line-of-sight (LOS)/non-line-of-sight (NLOS) indication information.

4. The method according to supplement 1, wherein the quality related information includes at least one of: error information, error level or range information, confidence information, signal to interference plus noise ratio (SINR) information, or reference signal receiving power (RSRP) information.

5. The method according to supplement 1, wherein the label data include location information, and the quality related information corresponding to the label data includes: information on a source of the label data and/or information on a wireless environment where the terminal equipment is located when the label data are acquired.

6. The method according to supplement 1, wherein the label data include LOS/NLOS indication information, and the quality related information corresponding to the label data includes: configuration information and/or evaluation indicator information for calculating LOS/NLOS state or statistical information (such as probability) of a wireless channel between the network device and the terminal equipment.

7. The method according to supplement 6, wherein the evaluation indicator information includes: calculation accuracy information, processing speed information and/or calculation complexity information.

8. The method according to any one of supplements 1 to 7, wherein the terminal equipment acquires and transmits the quality related information corresponding to a plurality of label data within a period of time for the plurality of label data.

9. The method according to supplement 8, wherein the terminal equipment performs statistics on all or part of the label data within the period of time to obtain the corresponding quality related information.

10. The method according to supplement 8, wherein the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

11. The method according to any one of supplements 1 to 10, wherein the method further includes:
receiving, by the terminal equipment, indication information from the network device;
and the terminal equipment transmits the label data and/or the quality related information corresponding to the label data to the network device according to the indication information.

12. The method according to supplement 11, wherein the terminal equipment transmits the label data and the quality related information together according to the indication information; or
the terminal equipment transmits the label data according to the indication information, then transmitting the quality related information; or
the terminal equipment transmits the quality related information according to the indication information, then transmitting the label data; or
the terminal equipment transmits the label data according to the indication information; or
the terminal equipment transmits the quality related information according to the indication information.

13. The method according to supplement 11, wherein the indication information indicates content, range or format of the quality related information.

14. The method according to supplement 11, wherein the indication information includes threshold information and/or counting information and/or time information for selecting the label data and/or the quality related information.

15. The method according to any one of supplements 1 to 14, wherein the method further includes:
transmitting, by the terminal equipment, feedback information to the network device.

16. The method according to supplement 15, wherein the feedback information includes at least one of: transmission completion confirmation information, transmission incompletion confirmation information, transmission incompletion reason information, or retransmission request information.

17. A method for receiving wireless positioning information, including:
receiving, by a network device, label data for wireless positioning and quality related information corresponding to the label data, from a terminal equipment.

18. The method according to supplement 17, wherein the method further includes:
transmitting, by the network device, indication information to the terminal equipment; and the terminal equipment transmits the label data and/or the quality related information corresponding to the label data to the network device according to the indication information.

19. The method according to supplement 17, wherein the method further includes:
receiving, by the network device, feedback information from the terminal equipment.

20. A method for transmitting wireless positioning information, including:
acquiring, by a network device, label data for wireless positioning and quality related information corresponding to the label data; and
transmitting, by the network device, the label data and/or the quality related information corresponding to the label data to a terminal equipment.

21. The method according to supplement 20, wherein the label data are used for operation and optimization of a wireless positioning model, and the quality related information is used to assist the label data in optimizing the wireless positioning model.

22. The method according to supplement 20, wherein the label data include at least one of: location information, time information, angle information, or line-of-sight (LOS)/non-line-of-sight (NLOS) indication information.

23. The method according to supplement 20, wherein the quality related information includes at least one of: error information, error level or range information, confidence information, signal to interference plus noise ratio (SINR) information, or reference signal receiving power (RSRP) information.

24. The method according to supplement 20, wherein the label data include location information, and the quality related information corresponding to the label data includes: information on a source of the label data and/or information on a wireless environment where the terminal equipment is located when the label data are acquired.

25. The method according to supplement 20, wherein the label data include LOS/NLOS indication information, and the quality related information corresponding to the label data includes: configuration information and/or evaluation indicator information for calculating LOS/NLOS state or statistical information (such as probability) of a wireless channel between the network device and the terminal equipment.

26. The method according to supplement 25, wherein the evaluation indicator information includes calculation accuracy information, processing speed information and/or calculation complexity information.

27. The method according to any one of supplements 20 to 26, wherein the network device acquires and transmits the quality related information corresponding to a plurality of label data within a period of time for the plurality of label data.

28. The method according to supplement 27, wherein the network device performs statistics on all or part of the label data within the period of time to obtain the corresponding quality related information.

29. The method according to supplement 27, wherein the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

30. The method according to any one of supplements 20 to 29, wherein the method further includes:
receiving, by the network device, request information from the terminal equipment;
and the network device transmits the label data and/or the quality related information corresponding to the label data to the terminal equipment according to the request information.

31. The method according to supplement 30, wherein the network device transmits the label data and the quality related information together according to the request information; or
the network device transmits the label data according to the request information, then transmitting the quality related information; or
the network device transmits the quality related information according to the request information, then transmitting the label data; or
the network device transmits the label data according to the request information; or
the network device transmits the quality related information according to the request information.

32. The method according to supplement 30, wherein the request information indicates content, range or format of the quality related information.

33. The method according to supplement 30, wherein the request information includes threshold information and/or counting information and/or time information for selecting the label data and/or the quality related information.

34. The method according to any one of supplements 20 to 33, wherein the method further includes:
transmitting, by the network device, feedback information to the terminal equipment.

35. The method according to supplement 34, wherein the feedback information includes at least one of: transmission completion confirmation information, transmission incompletion confirmation information, transmission incompletion reason information, or retransmission request information.

36. A method for receiving wireless positioning information, including:
receiving, by a terminal equipment, label data for wireless positioning and quality related information corresponding to the label data from a network device.

37. The method according to supplement 36, wherein the method further includes:
transmitting, by the terminal equipment, request information to the network device;
and the terminal equipment transmits the label data and/or the quality related information corresponding to the label data to the network device according to the request information.

38. The method according to supplement 36, wherein the method further includes:
receiving, by the terminal equipment, feedback information from the network device.

39. A terminal equipment, including a memory configured to store a computer program, and a processor configured to execute the computer program to implement a method for transmitting wireless positioning information according to any one of supplements 1 to 16, or to implement a method for receiving wireless positioning information according to any one of supplements 36 to 38.

40. A network device, including a memory configured to store a computer program, and a processor configured to execute the computer program to implement a method for transmitting wireless positioning information according to any one of supplements 17 to 32, or to implement a method for receiving wireless positioning information according to any one of supplements 33 to 35.

41. A communication system, including:
the terminal equipment according to supplement 39; and
the network device according to supplement 40.

1. A device for transmitting wireless positioning information configured in a terminal equipment, comprising:
acquiring processor circuitry configured to acquire label data for wireless positioning and quality related information corresponding to the label data; and
a transmitter configured to transmit the label data and/or the quality related information corresponding to the label data to a network device.

2. The device according to claim 1, wherein the label data are used for operation and optimization of a wireless positioning model, and the quality related information is used to assist the label data in optimizing the wireless positioning model.

3. The device according to claim 1, wherein the label data includes at least one of: location information, time information, angle information, or line-of-sight (LOS)/non-line-of-sight (NLOS) indication information.

4. The device according to claim 1, wherein the quality related information includes at least one of: error information, error level or range information, confidence information, signal to interference plus noise ratio (SINR) information, or reference signal receiving power (RSRP) information.

5. The device according to claim 1, wherein the label data includes location information, and the quality related information corresponding to the label data includes: information on a source of the label data and/or information on a wireless environment where the terminal equipment is located when the label data are acquired.

6. The device according to claim 1, wherein the label data includes LOS/NLOS indication information, and the quality related information corresponding to the label data includes: configuration information and/or evaluation indicator information for calculating LOS/NLOS state or statistical information of a wireless channel between the network device and the terminal equipment.

7. The device according to claim 6, wherein the evaluation indicator information includes: calculation accuracy information, processing speed information and/or calculation complexity information.

8. The device according to claim 1, wherein the terminal equipment acquires and transmits the quality related information corresponding to a plurality of label data for the plurality of label data.

9. The device according to claim 8, wherein the terminal equipment performs statistics on all or part of the label data within a period of time to obtain the corresponding quality related information.

10. The device according to claim 8, wherein the quality related information corresponding to the plurality of label data includes at least one of: error range information of the plurality of label data, a maximum error of the plurality of label data, a minimum error of the plurality of label data, an average error of the plurality of label data, a median error of the plurality of label data, or an error confidence of the plurality of label data.

11. The device according to claim 1, the device further comprising:
a receiver configured to receive indication information from the network device; and
wherein the transmitter transmits the label data and/or the quality related information corresponding to the label data to the network device according to the indication information.

12. The device according to claim 11, wherein the transmitter transmits the label data and the quality related information together according to the indication information; or
the terminal equipment transmits the label data according to the indication information, then transmits the quality related information; or
the terminal equipment transmits the quality related information according to the indication information, then transmits the label data; or
the terminal equipment transmits the label data according to the indication information; or
the terminal equipment transmits the quality related information according to the indication information.

13. The device according to claim 11, wherein the indication information indicates content, range or format of the quality related information.

14. The device according to claim 11, wherein the indication information includes threshold information and/or counting information and/or time information for selecting the label data and/or the quality related information.

15. The device according to claim 1, wherein the transmitter further transmits feedback information to the network device.

16. The device according to claim 15, wherein the feedback information includes at least one of: transmission completion confirmation information, transmission incompletion confirmation information, transmission incompletion reason information, or retransmission request information.

17. A device for receiving wireless positioning information configured in a network device, comprising:
a receiver configured to receive label data for wireless positioning and quality related information corresponding to the label data from a terminal equipment.

18. The device according to claim 17, the device further comprising:
a transmitter configured to transmit indication information to the terminal equipment; and wherein the terminal equipment transmits the label data and/or the quality related information corresponding to the label data to the network device according to the indication information.

19. The device according to claim 17, wherein the receiver further receives feedback information from the terminal equipment.

20. A communication system, comprising:
a terminal equipment configured to acquire label data for wireless positioning and quality related information corresponding to the label data, and transmit the label data and/or the quality related information corresponding to the label data to a network device; and
the network device configured to receive the label data and the quality related information corresponding to the label data.
